(19) United States
(12) Patent Application Publication
(10) Pub. No.: US 2005/0131136 A1
(43) Pub. Date: Jun. 16, 2005

(54) Soft polyurethaneurea spray elastomers with improved abrasion resistance

(76) Inventors: James W. Rosthauser, Pittsburgh, PA (US); John H. Perry, Scenery Hill, PA (US); James R. Charron, Pittsburgh, PA (US)

Correspondence Address: BAYER MATERIAL SCIENCE LLC, 100 BAYER ROAD, PITTSBURGH, PA, 15205, US

(21) Appl. No.: 10/737,605

(22) Filed: Dec. 16, 2003

(51) Int. Cl. C08K 3/00

(52) U.S. Cl. 524/589

(57) ABSTRACT

The present invention relates to novel spray elastomers which exhibit improved abrasion resistance. Other aspects of this invention are soft molded composites and processes of making these composites. These composites may also be decorative and/or pigmented composites.

### BACKGROUND OF THE INVENTION

The present invention relates to spray elastomers and a process for preparing these spray elastomers. These are the reaction product of a polyisocyanate with an isocyanate-reactive component containing an internal mold release agent. This invention also relates to an improved process for the production of molded soft composites, and the resultant composites.

Soft composite materials are generally used in seating applications, exercise equipment pads, support pads in spas and jacuzzis, automotive interior parts, etc. Typically, composite materials such as these are prepared from a foam which is subsequently covered with a flexible material such as, for example, vinyl or fabric.

Such processes for producing flexible foams covered with soft materials are known. Problems associated with these processes and the corresponding products include additional process steps/labor requirements, additional equipment, increased cycle time, and generation of waste material.

Recent developments in the automobile industry include developing non-fabric automotive trim components. Known systems for producing decorative components include polyvinyl chloride (PVC) vacuum and rotocast systems, thermoplastic polyolefin (TPO), vacuum formed systems, thermoplastic polyurethane (TPU) rotocast and spray aliphatic urethane systems. Each of these has problems associated with the material and/or the process.

Aside from the environmental issues associated with, for example, PVC, skins based on PVC are stiff and have a poor feel. Stiffness and a poor feel are also common problems for TPO vacuum formed skins. The TPO systems are also known to result in poor quality grain definition. Finally, TPO systems require an additional coating to be scratch-resistant.

U.S. Pat. No. 5,116,557 describes integral skin applications and a method for making mold components having a low density. The method sprays a layer of light stable polyurethane elastomer of a pre-determined color onto a mold surface and then injects a synthetic foam composition into the space of the mold cavity while the elastomer is still tacky. After curing, the molded object is removed. This process, while overcoming some short-comings of earlier known processes, will increase cost and possibly require additional steps to ensure adhesion with a urethane foam. Other known problems include issues related to matching of color, poor fog resistance and a poor feel of the produced skins.

Soft molded composites based on polyurethane and polyurethane ureas and processes for making these are described in U.S. Pat. No. 6,294,248. These processes require the elastomer-forming composition to have a gel time of from about 15 to about 120 seconds. This is to ensure that the elastomer coating on the walls of the mold is sufficiently set so that the foam-forming mixture will be substantially contained within the elastomeric coating. Composite articles are produced in a simple one-step process with relatively short cycle times. This molding process generates little waste and requires less labor and equipment than current commercial processes.

U.S. Pat. No. 6,432,543 discloses a specific sprayable elastomer composition for making components which are particularly suitable for the automotive industry. These components have a molded elastomeric outer layer and an inner polyurethane foam layer. The elastomer is the reaction product of an aromatic polyisocyanate, a solids containing polyol, a second polyol, and other additives. The total solids content of all components except the polyisocyanate is up to 40 wt. %. Hardness of elastomers containing this amount of solids is generally limited to the range of 70 to 85 Shore A.

Advantages of the present invention include the fact that the skins are soft and have a good feel. Hardness of the elastomers can be in the range of 40 to 85 Shore A. Abrasion resistance is improved by incorporating the internal mold release agent into the isocyanate-reactive component.

### SUMMARY OF THE INVENTION

This invention relates to spray elastomers and to a process for preparing spray elastomers.

The spray elastomers of the present invention are soft polyurethaneurea elastomers which- exhibit improved abrasion resistance. These spray elastomers are the reaction product of:
(A) a polyisocyanate or prepolymer;
with
(B) an isocyanate-reactive component comprising:
   (1) from about 70 to about 97% by weight, based on 100% of the combined weight of components (B) and (C), of one or more compounds containing from about 1.5 to about 6 isocyanate-reactive groups having a molecular weight of from about 60 to about 8000, and an OH number of from about 14 to about 1870,
   and
   (2) from about 2.5to about 20% by weight, based on 100% of the combined weight of components (B) and (C), of one or more compounds containing from about 1.5 to about 4 primary or secondary amine groups, having a molecular weight of from about 60 to about 500, and an NH number of from about 225 to about 1870;
(C) from about 0.5 to 10% by weight, based on 100% of the combined weight of components (B) and (C), of one or more internal mold release agents which comprises:
   (1) one or more zinc carboxylates containing from about 8 to about 24 carbon atoms per carboxylate group (most preferably zinc stearate);
   and
   (2) a compatibilizer for the zinc carboxylate which is selected from the group consisting of:
      (a) amine-terminated polyether polyols;
      (b) hydroxyl-terminated amine-initiated polyether polyols;
      and
      (c) mixtures thereof;
and, optionally,
(D) one or more catalysts,
(E) one or more anti-oxidants,
(F) one or more UV stabilizers,
and
(G) one or more colorants,
   wherein the ratio of the total number of isocyanate groups present to the total number of isocyanate-reactive groups present is from about 0.80 to about 1.20.

The present invention also relates to soft molded composites comprising these and to an improved process for the production of these composites.

These composites are produced by (1) applying, preferably by spraying, a composition which forms a soft polyurethaneurea elastomeric layer after application to all of the interior walls of an open mold, (2) closing the mold, (3) introducing a composition which will form a low density, high resiliency, flexible foam under molding conditions applied to the mold in a manner such that the foam-forming composition will be substantially completely within the elastomer-forming composition, and (4) allowing the foam-forming composition introduced in (3) to react. In this process, the composition which is applied in (1) is the spray polyurethane-urea elastomer described above. The molded composite is removed from the mold once the foam-forming reaction is completed.

It is also possible for the foam-forming composition to be introduced into the mold before the mold is closed. However, it is still necessary to close the mold prior to completion of foam-formation. As above, the molded composite is removed from the mold after the foam-forming reaction is completed.

In an alternative method, a composite is produced in a mold by (1) applying, preferably by spraying, an elastomer composition over the surface of the mold cavity and allowing the elastomer composition to at least partially cure to form an elastomeric layer, (2) introducing a foam-forming composition into the mold cavity and applying the foam-forming composition to the at least partially cured elastomeric layer to form a backing layer on the component, and (3) demolding the resulting composite. In this aspect of the present invention, the elastomer composition applied in (1) is the spray elastomer composition described above.

Optional embodiments of the above described alternative method include forming soft composites which are useful as decorative composites or components, and/or colored/pigmented composites. This can be accomplished, for example, by first applying a coating composition having the desired color or pigment to the inside surface of the mold cavity, and proceeding as described above in steps (1)-(3).

It is also possible to prepare these soft composites (including decorative and/or pigmented/colored components) by first applying a first coating having the desired color or pigment to the inside surface of the mold cavity, and then applying (preferably by spraying) an elastomer composition over the surface of the mold cavity and allowing the elastomer composition to at least partially cure to form an elastomeric layer, and demolding the soft composite. A polyurethane foam forming composition can now be applied to the elastomeric layer to form a backing layer. Subsequent coating applications can be applied over the first coating too, if desired.

It can also be accomplished by applying a coating composition having the desired color or pigment to the elastomeric layer after demolding the molded composite. This process requires completing steps (1)-(3) as described above first, and coating the outer elastomeric layer of the composite with a coating containing the desired colorant or pigment.

### DETAILED DESCRIPTION OF THE INVENTION

Sprayable elastomers of the present invention comprise the reaction product of:
(A) a polyisocyanate or prepolymer thereof with an isocyanate content from about 6 to 20%, preferably 8 to 16% and most preferably 9 to 13%;
with
(B) an isocyanate-reactive component comprising:
   (1) from about 70 to about 97%, preferably 80 to 96%, most preferably 85 to 95% by weight, based on 100% of the combined weight of components (B) and (C), of one or more compounds containing from about 1.5 to about 6 isocyanate-reactive groups (may be any NCO-reactive group including OH, SH, etc., except primary or secondary NH groups; is preferably OH), having a molecular weight of from about 60 to about 8000, and an OH number of from about 14 to about 1870,
   and
   (2) from about 2.5 to about 20%, preferably 3 to 15%, most preferably 5 to 12% by weight, based on 100% of the combined weight of components (B) and (C), of one or more compounds containing from about 1.5 to about 4 primary or secondary amine groups, having a molecular weight of from about 60 to about 500, and an NH number of from about 225 to about 1870;
(C) from about 0.5 to about 10.0%, more preferably from about 1 to about 6% and most preferably from about 2 to about 4% by weight, based on 100% of the combined weight of components (B) and (C), of one or more internal mold release agents, which preferably comprises:
   (1) from 5 to 50%, preferably 10 to 40%, most preferably 15 to 30% by weight, based on 100% by weight of (C), of one or more zinc carboxylates containing from about 8 to about 24 carbon atoms per carboxylate group (most preferably zinc stearate);
   and
   (2) from 50 to 95%, preferably 60 to 90%, most preferably 70 to 85% by weight, based on 100% by weight of (C), of a compatibilizer selected from the group consisting of:
      (a) amine-terminated polyether polyols having a functionality of from 2 to 4 and a molecular weight of from 200 to 5000;
      (b) hydroxyl-terminated amine-initiated polyether polyols having a functionality of from 2 to 4 and a molecular weight of from 200 to 8000;
      and
      (c) mixtures thereof;
and, optionally,
(D) one or more catalysts, (preferably one or more amine catalysts in an OH group containing material)
(E) one or more anti-oxidants,
(F) one or more UV stabilizers,
and
(G) one or more colorants,
   wherein the ratio of the total number of isocyanate groups present to the total number of isocyanate-reactive groups present is from about 0.80 to about 1.20. In these sprayable elastomers, it is preferred that the ratio of the total number of isocyanate groups present to the total number of isocyanate-reactive groups present is from about 0.90 to about 1.10, and most preferably from about 0.95 to about 1.05.

Suitable polyisocyanates and/or prepolymers thereof to be used as component (A) in the present invention typically have NCO group contents from about 6 to about 20%. These polyisocyanates and prepolymers typically have NCO group contents of at least about 6%, preferably at least about 8% and most preferably at least about 9%. The polyisocyanates and prepolymer suitable herein also typically have NCO group contents of less than or equal to 20%, preferably of less than or equal to 16% and most preferably of less than or equal to 13%. The polyisocyanates and prepolymers may have an NCO group content ranging between any combination of these upper and lower values, inclusive, e.g., from 6 to 20%, preferably from 8 to 16% and most preferably from 9 to 13%.

The suitable polyisocyanates and prepolymers thereof are based on diphenylmethane diisocyanates and polyphenylmethane polyisocyanates which have the above disclosed NCO group contents. It is preferred that the polyisocyanate component comprise 100% by weight of diphenylmethane diisocyanate and 0% by weight of polyphenylmethane polyisocyanate, with the sums totaling 100% of the polyisocyanate.

These polyisocyanates typically have a monomeric MDI content of at least about 50%, preferably of at least about 75%, more preferably of at least about 85% and most preferably of at least about 95%. The polyisocyanates also typically have a monomeric MDI content of less than or equal to about 100%. These polyisocyanates may have a monomeric MDI content ranging between any combination of these upper and lower values, inclusive, e.g., from 50 to 100%, preferably from 75 to 100%, more preferably from 85 to 100% and most preferably from 95 to 100%.

In addition, these polyisocyanates typically have a polymeric MDI content of at least about 0%. The polyisocyanates also typically have a polymeric MDI content of less than or equal to about 50%, preferably less than or equal to about 25%, more preferably less than or equal to about 15% and most preferably less than or equal to about 5%. These polyisocyanates may have a polymeric MDI content ranging between any combination of these upper and lower values, inclusive, e.g., from 0 to 50%, preferably from 0 to 25%, more preferably from 0 to 15% and most preferably from 0 to 5%.

Suitable polyisocyanates of the above described monomeric MDI contents, typically have an isomer distribution of 2,2′-, 2,4′- and 4,4′-MDI as follows. The % by weight of (1) the 2,4′-isomer of diphenylmethane diisocyanate is typically at least about 2%, preferably at least about 10%, more preferably at least about 25% and most preferably at least about 40%. The % by weight of (1) the 2,4′-isomer generally is about 60 or less, and most preferably of about 55% or less. The diphenylmethane diisocyanate component may have (1) a 2,4′-isomer content ranging between any of these upper and lower values, inclusive, e.g., from 2 to 60%, preferably from 10 to 60%, more preferably from 25 to 60% and most preferably from 40 to 55%. The % by weight of the (2) 2,2′-isomer of diphenylmethane diisocyanate is typically at least about 0%, and preferably about 0%. The % by weight of (2) the 2,2′-isomer generally is about 5% or less, preferably of about 2% or less. The diphenylmethane diisocyanate component may have (2) a 2,2′-isomer content ranging between any of these upper and lower values, inclusive, e.g., from 0 to 5%, and preferably from 0 to 2%. The % by weight of (3) the 4,4′-isomer of diphenylmethane diisocyanate is typically at least about 40%, preferably at least about 40%, more preferably at least about 40% and most preferably at least about 45%. The % by weight of (3) the 4,4′-isomer generally is about 98% or less, preferably of about 90% or less, more preferably of about 75% or less, and most preferably of about 60% or less. The diphenylmethane diisocyanate component may have (3) a 4,4′-isomer content ranging between any of these upper and lower values, inclusive, e.g., from 40 to 98%, preferably from 40 to 90%, more preferably from 40 to 75% and most preferably from 45 to 60%. The %'s by weight of the isomers (1), (2) and (3) always total 100% by weight of the monomeric diphenylmethane diisocyanate.

In the embodiment wherein (A) the isocyanate component comprises an isocyanate prepolymer, these are typically prepared by reacting a suitable polyisocyanate component as described above, with an isocyanate-reactive component such that the resultant prepolymer has an NCO group content as described herein above. The prepolymer may have an NCO group content ranging between any combination of these upper and lower values, inclusive, e.g., as previously described. Generally, the relative amounts of polyisocyanate and isocyanate-reactive component are such that there is an excess of NCO groups present.

Suitable prepolymers will also typically have a functionality of at least about 1.5, more preferably at least about 2 and most preferably at least about 2. These prepolymers typically have a functionality of less than or equal to 3, preferably less than or equal to 2.5 and most preferably less than or equal to 2.1. The prepolymer may have a functionality ranging between any combination of these upper and lower values, inclusive, e.g., of from about 1.5 to about 3, preferably from about 2 to about 2.5 and most preferably from about 2 to about 2.1.

The urethane group contents of these prepolymers is typically at least about 0.1%, more preferably at least about 0.2% and most preferably at least about 0.3%. These prepolymers typically have a urethane group content of less than or equal to 5%, preferably less than or equal to 3.5% and most preferably less than or equal to 2.8%. The prepolymer may have a urethane group content ranging between any combination of these upper and lower values, inclusive, e.g., of from about 0.1% to about 5%, preferably from about 0.2% to about 3.5% and most preferably from about 0.3% to about 2.8%.

These prepolymers typically have a viscosity of at least about 100 mPa.s, more preferably at least about 200 mPa.s and most preferably at least about 500 mPa.s. These prepolymers typically have a viscosity of less than or equal to 10,000 mPa.s, preferably less than or equal to 5,000 mPa.s and most preferably less than or equal to 3,000 mPa.s. The prepolymer may have a viscosity ranging between any combination of these upper and lower values, inclusive, e.g., of from about 100 to about 10,000 mPa.s, preferably from about 200 to about 5,000 mPa.s and most preferably from about 500 to about 3,000 mPa.s.

In the prepolymers, any of the previously described polyisocyanate based on diphenylmethane diisocyanate, polymethylene polyphenyl-isocyanates and mixtures thereof are suitable. The isocyanate-reactive component is, generally speaking, an organic compound which contains at least about 1.5, preferably at least about 1.8 and most preferably at least about 1.9 functional groups which are capable of reacting with the isocyanate groups. These compounds also typically contain less than or equal to about 3, preferably less than or equal to about 2.5 and most preferably less than or equal to about 2.3 functional groups which are capable of reacting with the isocyanate groups. The isocyanate-reactive component may contain a number of functional groups ranging between any combination of these upper and lower values, inclusive, e.g., from 1.5 to 3, preferably from 1.8 to 2.5 and most preferably from 1.9 to 2.3. Suitable isocyanate-reactive groups include OH groups, NH groups, SH groups, etc., with OH groups being particularly preferred.

Suitable molecular weight ranges for these isocyanate-reactive compounds to be used in preparation of the prepolymers are at least about 200, preferably at least about 500 and most preferably at least about 1,000. These compounds also typically have a molecular weight of less than or equal to about 8,000, preferably less than or equal to about 6,000 and most preferably less than or equal to about 3,000. The isocyanate-reactive component may have a molecular weight ranging between any combination of these upper and lower values, inclusive, e.g., from 200 to 8,000, preferably from 500 to 6,000 and most preferably from 1,000 to 3,000.

Suitable compounds to be used as the isocyanate-reactive component to be used in preparation of the prepolymers include, for example, but are not limited to, polyether polyols, polyester polyol, polycarbonate diols, polyhydric polythioethers, polyacetals, aliphatic thiols, etc. Preferred isocyanate-reactive components for making the prepolymer are polyether polyols. Obviously, these preferred polyether polyols satisfy the above described limits in terms of both molecular weight and functionality.

A particularly preferred isocyanate to be used as component (A) in the presently claimed invention comprises an isocyanate-terminated prepolymer having an NCO content of about 6 to about 20%, preferably of about 8 to 16% and most preferably about 9 to 13%; a functionality of about 1.5 to 3, preferably of about 1.8 to about 2.5 and most preferably about 2; and a viscosity of about 100 to about 10,000 mPa.s, preferably about 200 to about 5,000 mPa.s and most preferably about 2,000 to about 3,000 mPa.s at 25° C. Such prepolymers can be prepared by reacting i) from about 50 to about 150, preferably about 75 to about 125 and most preferably about 100 parts by weight of distilled 2,4′-isomer rich MDI having an NCO content of about 30 to about 33.6%, preferably about 32 to about 33.6% and most preferably about 33 to about 33.6%; a functionality of about 2.0 to about 2.3, preferably about 2.0 to about 2.1 and most preferably about 2.0; a viscosity of about 25 to about 180, preferably about 25 to about 100 and most preferably about 25 to about 50 mPa.s at 25° C.; and having an isomer distribution of about 44 to about 98%, preferably about 44 to about 70% and most preferably about 44 to about 60% by wt. of the 4,4′-isomer, from about 2 to about 54%, preferably about 30to about 54% and most preferably about 40 to about 54% by wt. of the 2,4′-isomer, and from 0 to about 5%, preferably about 0.2 to about 2.5% and most preferably about 0.5 to about 2% by wt. of the 2,2′-isomer; with ii) from about 100 to about 250, preferably about 150 to about 200 and most preferably about 160 to about 170 parts by weight of a polyether polyol (most preferably one initiated from propylene glycol with propylene oxide) having a molecular weight of from about 200 to about 8,000, preferably from about 500 to about 6,000 and most preferably about 1,000 to about 3,000; having a functionality of from about 1.5 to about 3, preferably from about 1.8 to about 2.5 and most preferably of about 2.

It is most particularly preferred that these prepolymers have an NCO group content of about 9 to about 13%, a functionality of about 2, a urethane content of about 0.2 to about 3%, and a viscosity of 2,000 to about 3,000 mPa.s at 25° C.

Suitable isocyanate-reactive components to be used as (B) in the present invention include (1) one or more compounds containing isocyanate-reactive groups, excluding primary and/or secondary NH groups, and (2) one or more compounds containing from about 2 to about 4 primary and/or secondary amine groups.

Suitable isocyanate-reactive groups for component (B)(1) typically include OH groups, SH groups, etc. Compounds containing virtually any type of reactive group which is capable of reaction with an NCO group from the polyisocyanate component (A) are suitable for use as component (B)(1), provided that they satisfy the requirements in terms of molecular weight, number of functional groups, OH number, etc. as set forth below. Obviously, components (B)(1) and (B)(2) are mutually exclusive, so (B)(1) compounds will, in general, not contain primary and/or secondary NH groups as these compounds are within the scope of (B)(2). In a preferred embodiment, component (B)(1) contains OH or SH groups, and most preferably OH groups.

Suitable compounds to be used as component (B)(1) in accordance with the present invention typically contain at least about 1.5 isocyanate-reactive groups, more preferably at least about 2 and most preferably at least about 2 isocyanate-reactive groups. These compounds also typically contain less than or equal to about 6 isocyanate-reactive groups, more preferably less than or equal to about 4 and most preferably less than or equal to about 3 isocyanate-reactive groups. It is also possible that these compounds have any number of isocyanate-reactive groups ranging between any combination of these upper and lower values, inclusive, e.g., from about 1.5 to about 6, more preferably from 2 to 4 and most preferably from about 2 to about 3.

Suitable compounds to be used as component (B)(1) in accordance with the present invention typically have a molecular weight of at least about 60, more preferably at least about 500 and most preferably at least about 1,000. These compounds also typically have a molecular weight of less than or equal to about 8,000, more preferably less than or equal to about 7,000 and most preferably less than or equal to about 6,000. It is also possible that these compounds have any molecular weight ranging between any combination of these upper and lower values, inclusive, e.g., from about 60 to about 8,000, more preferably from about 500 to about 7,000 and most preferably from about 1,000 to about 6,000.

Suitable compounds to be used as component (B)(1) in accordance with the present invention typically have an OH number of at least about 14, more preferably at least about 20 and most preferably at least about 26. These compounds also typically have an OH number of less than or equal to about 1870, more preferably less than or equal to about 600 and most preferably less than or equal to about 300. It is also possible that these compounds have any OH number ranging between any combination of these upper and lower values, inclusive, e.g., from about 14 to about 1870, more preferably from about 20 to about 600 and most preferably from about 26 to about 300.

Examples of suitable compounds to be used as component (B)(1) in the present invention include compounds such as, for example, polyether polyols, polyester polyols, polycarbonate diols, polyhydric polythioethers, polyacetals, aliphatic thiols, solids containing polyols including those selected from the group consisting of graft polyols, polyisocyanate polyaddition polyols, polymer, polyols, PHD polyols and mixtures thereof, etc. Lower molecular weight polyether polyols which are sometimes referred to as chain extenders and/or crosslinkers are also suitable for component (B)(1), provided they are within the ranges set forth above for functionality, molecular weight and OH number, and satisfy the requirements for types of isocyanate-reactive groups. It is preferred to use a polyether polyol as (B)(1).

Hydroxyl-containing polyethers are suitable for use as isocyanate-reactive component (B). Suitable hydroxyl-containing polyethers can be prepared, for example, by the polymerization of epoxides such as ethylene oxide, propylene oxide, butylene oxide, tetrahydrofuran, styrene oxide, or epichlorohydrin, optionally in the presence of BF₃, or by chemical addition of such epoxides, optionally as mixtures or successively, to starting components containing reactive hydrogen atoms, such as water, alcohols, or amines. Examples of such starting components include ethylene glycol, 1,2- or 1,3-propanediol, 1,2-, 1,3-, or 1,4-butanediol, glycerin, trimethylolpropane, pentaerythritol, 4,4′-dihydroxydiphenyl-propane, aniline, 2,4- or 2,6-diaminotoluene, ammonia, ethanolamine, triethanolamine, or ethylene diamine. Sucrose polyethers of the type described, for example, in German Auslegeschriften 1,176,358 and 1,064,938 may also be used according to the invention. Polyethers that contain predominantly primary hydroxyl groups (up to about 90% by weight, based on all of the hydroxyl groups in the polyether) are particularly preferred. Polyethers modified by vinyl polymers of the kind obtained, for example, by the polymerization of styrene and acrylonitrile in the presence of polyethers (e.g., U.S. Pat. Nos. 3,383,351, 3,304,273, 3,523,093, and 3,110,695 and German Patentschrift 1,152,536) are also suitable, as are polybutadienes containing hydroxyl groups. Particularly preferred polyethers include polyoxyalkylene polyether polyols, such as polyoxyethylene diol and triol, polyoxypropylene diol and triol, and polyoxypropylene diols and triols that have been capped with polyoxyethylene blocks.

Hydroxyl-containing polyesters are also suitable for use as isocyanate-reactive component (B). Suitable hydroxyl-containing polyesters include reaction products of polyhydric alcohols (preferably diols), optionally with the addition of trihydric alcohols, and polybasic (preferably dibasic) carboxylic acids. Instead of free polycarboxylic acids, the corresponding polycarboxylic acid anhydrides or corresponding polycarboxylic acid esters of lower alcohols or mixtures thereof may be used for preparing the polyesters. The polycarboxylic acids may be aliphatic, cycloaliphatic, aromatic, or heterocyclic and may be substituted, e.g., by halogen atoms, and/or unsaturated. Suitable polycarboxylic acids include succinic acid, adipic acid, suberic acid, azelaic acid, sebacic acid, phthalic acid, isophthalic acid, trimellitic acid, phthalic acid anhydride, tetrahydrophthalic acid anhydride, hexahydrbphthalic acid anhydride, tetrachlorophthalic acid anhydride, endo-methylene tetrahydrophthalic acid anhydride, glutaric acid anhydride, maleic acid, maleic acid anhydride, fumaric acid, dimeric and trimeric fatty acids, dimethyl terephthalic, and terephthalic acid bis-glycol esters. Suitable polyhydric alcohols include ethylene glycol, 1,2- and 1,3-propanediol, 1,4- and 2,3-butanediol, 1,6-hexanediol, 1,8-octanediol, neopentyl glycol, 1,3- and 1,4-bis(hydroxymethyl) cyclohexane, 2-methyl-1,3-propanediol, glycerol, trimethylolpropane, 1,2,6-hexanetriol, 1,2,4-butanetriol, trimethylolethane, pentaerythritol, quinitol, mannitol, sorbitol, methyl glycoside, diethylene glycol, triethylene glycol, tetraethylene glycol, polyethylene glycols, dipropylene glycol, polypropylene glycols, dibutylene glycol, and polybutylene glycols. The polyesters may also contain a proportion of carboxyl end groups. Polyesters of lactones, such as ε-caprolactone, or of hydroxycarboxylic acids, such as ω-hydroxycaproic acid, may also be used. Hydrolytically stable polyesters are preferably used in order to obtain the greatest benefit relative to the hydrolytic stability of the final product. Preferred polyesters include polyesters obtained from adipic acid or isophthalic acid and straight chained or branched diols, as well as lactone polyesters, preferably those based on caprolactone and diols.

Suitable polyacetals include compounds obtained from the condensation of glycols, such as diethylene glycol, triethylene glycol, 4,4′-dihydroxydiphenylmethane, and hexanediol, with formaldehyde or by the polymerization of cyclic acetals, such as trioxane.

Suitable polycarbonates include those prepared by the reaction of diols, such as 1,3-propanediol, 1,4-butanediol, 1,6-hexanediol, diethylene glycol, triethylene glycol, tetraethylene glycol, or thiodiglycol, with phosgene or diaryl carbonates such as diphenyl carbonate (German Auslegeschriften 1,694,080, 1,915,908, and 2,221,751; German Offenlegungsschrift 2,605,024).

Suitable polyester carbonates include those prepared by the reaction of polyester diols, with or without other diols such as 1,3-propanediol, 1,4-butanediol, 1,6-hexanediol, diethylene glycol, triethylene glycol, tetraethylene glycol, or thiodiglycol, with phosgene, cyclic carbonates, or diaryl carbonates such as diphenyl carbonate. Suitable polyester carbonates more generally include compounds such as those disclosed in U.S. Pat. No. 4,430,484.

Suitable polythioethers include the condensation products obtained by the reaction of thiodiglycol, either alone or with other glycols, formaldehyde, or amino alcohols. The products obtained are polythio-mixed ethers, polythioether esters, or polythioether ester amides, depending on the components used.

Although less preferred, other suitable hydroxyl-containing compounds include polyhydroxyl compounds already containing urethane or urea groups and modified or unmodified natural polyols. Products of addition of alkylene oxides to phenol-formaldehyde resins or to urea-formaldehyde resins are also suitable. Furthermore, amide groups may be introduced into the polyhydroxyl compounds as described, for example, in German Offenlegungsschrift 2,559,372.

General discussions of representative hydroxyl-containing compounds that may be us d according to the present invention can be found, for example, in Polyurethanes, Chemistry and Technology by Saunders and Frisch, Interscience Publishers, N.Y., London, Volume I, 1962, pages 32-42 and pages 44-54, and Volume II 1964, pages 5-6 and 198-199, and in Kunststoff-Handbuch, Volume VII, Vieweg-Hochtlen, Carl-Hanser-Verlag, Munich, 1966, on pages 45 to 71.

Other suitable hydroxyl-containing polyethers include those polyethers which have low molecular weights, i.e. from about 60 to less than about 399. Suitable hydroxyl-containing polyethers can be prepared, for example, by the methods discussed above for the hydroxy-containing polyethers except that only lower molecular weight polyethers are used. Particularly suitable polyethers include polyoxyalkylene polyether polyols, such as polyoxyethylene diol, polyoxypropylene diol, polyoxybutylene diol, and polytetramethylene diol having the requisite molecular weights.

Suitable compounds to be used as component (B)(2) in accordance with the present invention typically contain at least about 1.5 amine groups, preferably primary or secondary amine groups, more preferably at least about 1.8 and most preferably at least about 2 amine groups. These compounds also typically contain less than or equal to about 4 amine groups, more preferably less than or equal to about 3 and most preferably less than or equal to about 2.1 amine groups. It is also possible that these compounds have any number of isocyanate-reactive groups ranging between any combination of these upper and lower values, inclusive, e.g., from about 1.5 to about 4, more preferably from about 1.8 to about 3, and most preferably from about 2 to about 2.1.

Suitable compounds to be used as component (B)(2) in accordance with the present invention typically have a molecular weight of at least about 60, more preferably at least about 100 and most preferably at least about 150. These compounds also typically have a molecular weight of less than or equal to about 500, more preferably less than or equal to about 400 and most preferably less than or equal to about 300. It is also possible that these compounds have any molecular weight ranging between any combination of these upper and lower values, inclusive, e.g., from 60 to 500, more preferably from 100 to 400 and most preferably from 150 to 300.

Suitable compounds to be used as component (B)(2) in accordance with the present invention typically have an NH number of at least about 225, more preferably at least about 280 and most preferably at least about 370. These compounds also typically have an NH number of less than or equal to about 1870, more preferably less than or equal to about 1120 and most preferably less than or equal to about 750. It is also possible that these compounds have any NH number ranging between any combination of these upper and lower values, inclusive, e.g., from about 225 to about 1870, more preferably from about 280 to about 1120 and most preferably from about 370 to about 750.

Suitable isocyanate-reactive compounds containing amino groups include the so-called amine-terminated polyethers containing primary or secondary (preferably primary) aromatically or aliphatically (preferably aliphatically) bound amino groups. Compounds containing amino end groups can also be attached to the polyether chain through urethane or ester groups. These amine-terminated polyethers can be prepared by any of several methods known in the art. For example, amine-terminated polyethers can be prepared from polyhydroxyl polyethers (e.g., polypropylene glycol ethers) by a reaction with ammonia in the presence of Raney nickel and hydrogen (Belgian Patent 634,741). Polyoxyalkylene polyamines can be prepared by a reaction of the corresponding polyol with ammonia and hydrogen in the presence of a nickel, copper, chromium catalyst (U.S. Pat. No. 3,654,370). The preparation of polyethers containing amino end groups by the hydrogenation of cyanoethylated polyoxypropylene ethers is described in German Patentschrift 1,193,671. Other methods for the preparation of polyoxyalkylene (polyether) amines are described in U.S. Pat. Nos. 3,155,728 and 3,236,895 and in French Patent 1,551,605. French Patent 1,466,708 discloses the preparation of polyethers containing secondary amino end groups. Also useful are the polyether polyamines described in U.S. Pat. Nos. 4,396,729, 4,433,067, 4,444,910, and 4,530,941, the disclosures of which are herein incorporated by reference.

Aminopolyethers obtained by the hydrolysis of compounds containing isocyanate end groups are also preferred amine-terminated polyethers. For example, in a process disclosed in German Offenlegungsschrift 2,948,419, polyethers containing hydroxyl groups (preferably two or three hydroxyl groups) react with polyisocyanates to form isocyanate prepolymers whose isocyanate groups are then hydrolyzed in a second step to amino groups. Preferred amine-terminated polyethers are prepared by hydrolyzing an isocyanate compound having an isocyanate group content of from 0.5 to 40% by weight. The most preferred polyethers are prepared by first reacting a polyether containing two to four hydroxyl groups with an excess of an aromatic polyisocyanate to form an isocyanate terminated prepolymer and then converting the isocyanate groups to amino groups by hydrolysis. Processes for the production of useful amine-terminated polyethers using isocyanate hydrolysis techniques are described in U.S. Pat. Nos. 4,386,218, 4,456,730, 4,472,568, 4,501,873, 4,515,923, 4,525,534, 4,540,720, 4,578,500, and 4,565,645, European Patent Application 97,299, and German Offenlegungsschrift 2,948,419, all the disclosures of which are herein incorporated by reference. Similar products are also described in U.S. Pat. Nos. 4,506,039, 4,525,590, 4,532,266, 4,532,317, 4,723,032, 4,724,252, 4,855,504, and 4,931,595, the disclosures of which are herein incorporated by reference.

Other suitable amine-terminated polyethers include aminophenoxy-substituted polyethers described, for example, in European Patent Applications 288,825 and 268,849. Aminophenoxy-substituted polyethers can also be prepared, for example, by converting polyether polyols into nitrophenoxy-terminated polyeth rs (by reaction, for example, with chloronitrobenzenes), followed by hydrogenation. E.g., U.S. Pat. Nos. 5,079,225 and 5,091,582. In a preferred method, aminophenoxy-substituted polyethers are prepared by converting polyether polyols into the corresponding sulfonate derivatives, followed by reaction of the polyether sulfonate with an aminophenoxide.

The amine-terminated polyethers used in the present invention are in many cases mixtures with other isocyanate-reactive compounds having the appropriate molecular weight. These mixtures generally should contain (on a statistical average) two to four isocyanate reactive amino end groups.

Aminocrotonate-terminated derivatives of polyethers, as well as of other polyols described above, can be prepared from acetoacetate-modified polyethers as described, for example, in U.S. Pat. Nos. 5,066,824, and 5,151,470, the disclosures of which are herein incorporated by reference.

Amine chain extenders preferably contain exclusively aromatically bound primary or secondary (preferably primary) amino groups and preferably also contain alkyl substituents are also suitable for use as component (B)(2) in the present invention. Examples of such aromatic diamines include 1,4-diaminobenzene, 2,4- and/or 2,6-diaminotoluene, 2,4′and/or 4,4′-diaminodiphenylmethane, 3,3′-dimethyl-4,4′-diamino-diphenylmethane, 1-methyl-3,5-bis(methylthio)-2,4- and/or -2,6-diamino-benzene, 1,3,5-triethyl-2,4-diaminobenzene, 1,3,5-triisopropyl -2,4-diaminobenzene, 1-methyl -3,5-diethyl-2,4- and/or -2,6-diaminobenzene, 4,6-dimethyl-2-ethyl-1,3-diaminobenzene, 3,5,3′, 5′-tetraethyl-4,4-diamino-diphenylmethane, 3,5,3′, 5′-tetraisopropyl-4,4′-diaminodiphenylmethane, and 3,5-diethyl-3′,5′-diisopropyl-4,4′-diaminodiphenylmethane. Although generally less preferred, certain (cyclo)aliphatic diamines are also suitable. Suitable (cyclo)aliphatic diamine include 1,3-bis(amino-methyl)cyclo-hexane, m-xylylenediamine, 1,3,3-trimethyl-5,aminocyclohexane, 4,4′-methylene bis(cyclohexylamine), etc. Particularly suitable diamines are 1-methyl -3,5-diethyl-2,4- and/or -2,6-diaminobenzene, 1,3-bis(amino-methyl)cyclohexane, m-xylylenediamine, 1,3,3-trimethyl-5-inocyclohexane, and 4,4′-methylene bis(cyclohexylamine). Such diamines may, of course, also be used as mixtures.

In the present invention, the internal mold release agent (C) is typically present in an amount of from about 0.5 to about 10% by weight, preferably from about 1 to about 6% and most preferably from about 2 to about 4% by weight, based on 100% of the combined weight of components (B) and (C). Suitable internal mold release agents for the present invention comprise (1) one or more zinc carboxylates which contains from 8 to 24 carbon atoms per carboxylate group, and (2) a compatabilizer for the zinc carboxylate. Such IMRs are described in, for example, U.S. Pat. Nos. 4,519,965, 4,581,386 and 4,585,803, disclosures of which are herein incorporated by reference.

The suitable zinc carboxylates (C)(1) which may be used in the internal release agent mixture of the present invention are based on C₈-C₂₄, branched or straight chain fatty acids which may be saturated or unsaturated. The carboxylates also include the commercial preparations of a specific carboxylate which also contains impurities or by-products of other fatty acid derivatives. For example, commercial “stearates” may also contain significant quantities of palmitates, myristates, etc. and commercial “tall oil” derivatives normally contain mixtures of stearates, palmitates, oleates, etc. Examples of specific zinc carboxylates include zinc stearate, zinc oleate, zinc octoate, zinc laurate, zinc behenate, zinc ricinoleate and the like.

The preferred zinc carboxylates (C)(1 ) are those which remain soluble in combination with the compatibilizer when in admixture with the blend of isocyanate-reactive components, (B)(1), and the amine components, (B)(2). The most preferred zinc carboxylate is zinc stearate, especially those having a high purity such as Zinc Stearate Polymer Grade Type N from Witco, Zinc Stearate RSN 131 HS and IPS from Mallinckrodt and Zinc Stearate Heat Stable Polymer Grade from Nuodex.

Suitable compatibilizers (C)(2) are those which assist in compatibilizing or solubilizing the zinc carboxylates in the resin blend and/or in the reaction mixture without substantially affecting the processing characteristics of the reaction mixture or the physical properties or paintability of the molded articles produced therefrom. The compatibilizers generally are selected from the group consisting of (a) amine-terminated polyether polyols and (b) hydroxyl-terminated amine-initiated polyether polyols.

Among the suitable (a) amine-terminated polyether polyols are those having a functionality of at least about 2. These typically have a functionality of less than or equal to 4. Suitable amine-terminated polyether polyols may also have a functionality ranging between any combination of these upper and lower values, inclusive, e.g., from about 2 to about 4.

Suitable (a) amine-terminated polyether polyols are those having a molecular weight of at least about 200. These typically also have a molecular weight of less than or equal to about 5,000, and preferably less than or equal to 3,000. Suitable amine-terminated polyether polyols may also have a molecular weight ranging between any combination of these upper and lower values, inclusive, e.g., from about 200 to about 5,000 and preferably from about 200 to about 3,000.

Suitable compatibilizers to be used as (C)(2)(a) include polyether polyamines and amine-terminated polyethers (i.e., polyethers obtained by the addition of alkylene oxides such as ethylene oxide and/or propylene oxide to aromatic or aliphatic polyamines, optionally followed by amination). Specific examples of these nitrogen-containing, isocyanate-reactive polymers include polyoxypropylene diamine (supplied as Jeffamine D-230 from Huntsman), polyoxypropylene diamine (supplied as Jeffamine D-400 from Huntsman), polyoxypropylene diamine (supplied as Jeffamine D-2000 from Huntsman), polyoxypropylene triamine (supplied as Jeffamine T-403 from Huntsman), polyoxypropylene triamine (supplied as Jeffamine T-5000 from Huntsman), etc.

Among the suitable (C)(2)(b) hydroxyl-terminated amine-initiated polyether polyols are those having a functionality of at least about 2. These typically also have a functionality of less than or equal to about 4. Suitable hydroxyl-terminated amine-initiated polyether polyols may also have a functionality ranging between any combination of these upper and lower values, inclusive, e.g., from about 2 to about 4.

Suitable (C)(2)(b) hydroxyl-terminated amine-initiated polyether polyols are those having a molecular weight of at least about 200. These typically also have a molecular weight of less than or equal to about 8,000. Suitable amine-terminated polyether polyols may also have a molecular weight ranging between any combination of these upper and lower values, inclusive, e.g., from about 200 to 8,000.

Some examples of suitable hydroxyl-terminated, amine-initiated polyether polyols include but are not limited to, for example, those such as ethylene diamine-inititated polyether polyol, toluene diamine-based polyether polyol, ethanolamine initiated polyols, diethanolamine initiated polyols, triethanolamine initiated polyols, etc.

Preferred amine-based polyethers are-those initiated with an amine containing at least two nitrogens and which contain the group —N—C—C—N—, i.e. wherein there are two carbons between the nitrogens. Examples of these amines include aliphatic amines such as ethylene diamine, diethylene triamine, etc. and heterocyclic amines such as piperazine or imidazolidine. Especially preferred are the alkoxylation products, preferably ethoxylation products and more preferably the propoxylation products of ethylene diamine.

Regardless of the molecular weight of the compatibilizer, it should be used in an amount which is sufficient to solubilize the zinc carboxylate so that when the internal mold release agent mixture (C) is blended with component (B), the zinc carboxylate possesses improved resistance to precipitation.

Suitable catalysts, when present, to be used as component (D) in accordance with the present invention, include, for example, the various catalyts known amine catalysts and other catalysts capable of promoting the reaction between polyisocyanates (A) and isocyanate-reactive components (B).

Suitable catalysts (D) include tertiary amines and metal compounds known in the art. Suitable tertiary amine catalysts include triethylamine, tributylamine, N-methylmorpholine, N-ethylmorpholine, N,N, N′, N′-tetra-methylethylene diamine, pentamethyldiethylene triamine, and higher homologs (German Offenlegungsschriften 2,624,527 and 2,624,528), 1,4-diazabicyclo[2.2.2]octane, N-methyl-N′-(dimethylaminoethyl) piperazine, bis(dimethylaminoalkyl)piperazines (German Offenlegungsschrift 2,636,787), N,N-dimethylbenzylamine, N,N-dimethylcyclohexylamine, N,N-diethylbenzylamine, bis(N,N-diethyl-aminoethyl) adipate, N,N,N′,N′-tetramethyl-1,3-butanediamine, N,N-dimethyl-.beta.-phenylethylamine, 1,2-dimethylimidazole, 2-methylimidazole, monocyclic and bicyclic amidines (German Offenlegungsschrift 1,720,633), bis(dialkylamino)alkyl ethers (U.S. Pat. No. 3,330,782, German Auslegeschrift 030,558, and German Offenlegungsschriften 1,804,361 and 2,618,280), and tertiary amines containing amide groups (preferably formamide groups) according to German Offenlegungsschriften 2,523,633 and 2,732,292. The catalysts used may also be the known Mannich bases of secondary amines (such as dimethylamine) and aldehydes (preferably formaldehyde) or ketones (such as acetone) and phenols. Particularly preferred catalysts are Dabco® 33LV and Dabco® 1028, both available from Air Products Corp.

Suitable catalysts also include certain tertiary amines containing isocyanate reactive hydrogen atoms. Examples of such catalysts include triethanolamine, triisopropanoamine, N-methyidiethanolamine, N-ethyl-diethanolamine, N,N-dimethylethanolamine, their reaction products with alkylene oxides (such as propylene oxide and/or ethylene oxide) and secondary-tertiary amines according to German Offenlegungsschrift 2,732,292.

Other suitable catalysts include acid blocked amines (i.e. delayed action catalysts). Examples of acid-blocked amine catalysts include DABCO® 8154 catalyst based on 1,4-diazabicyclo[2.2.2]octane and DABCO® BL-17 catalyst based on bis(N,N-dimethylaminoethyl) ether (available from Air Products and Chemicals, Inc., Allentown, Pa.) and POLYCAT® SA-1, POLYCAT® SA-102, and POLYCAT® SA-610/50 catalysts based on POLYCAT® DBU amine catalyst (available from Air Products and Chemicals, Inc.) as are known and described in, for example, U.S. Pat. No. 5,973,099, the disclosure of which is herein incorporated by reference.

Examples of suitable organic acid blocked amine gel catalysts which may be employed are the acid blocked amines of triethylene-diamine, N-ethyl or methyl morpholine, N,N dimethylamine, N-ethyl or methyl morpholine, N,N dimethylaminoethyl morpholine, N-butyl-morpholine, N,N′ dimethylpiperazine, bis(dimethylamino-alkyl)-piperazines, 1,2 dimethyl imidazole, dimethyl cyclohexylamine. The blocking agent can be an organic carboxylic acid having 1 to 20 carbon atoms, preferably 1-2 carbon atoms. Examples of blocking agents include 2-ethyl-hexanoic acid and formic acid. Any stoichiometric ratio can be employed with one acid equivalent blocking one amine group equivalent being preferred. The tertiary amine salt of the organic carboxylic acid can be formed in situ, or it can be added-to the polyol composition ingredients as a salt. To this end, quaternary ammonium salts are particularly useful. Such acid blocked amine catalysts are known and described in, for example, U.S. Pat. No. 6,013,690, the disclosure of which is herein incorporated by reference.

Still other suitable amine catalysts include the organic acid blocked tertiary amines. Suitable organic carboxylic acids used to block the tertiary amine gel catalysts, if needed to provide a time delayed action, include mono- or dicarboxylic acids having 1-20 carbon atoms, such as formic, acetic, propionic, butyric, caproic, 2-ethyl-hexanoic, caprylic, cyanoacetic, pyruvic, benzoic, oxalic, malonic, succinic, and maleic acids, with formic acid being preferred. The organic acid blocked tertiary amine gel catalysts are usually dissolved in water or organic solvents to avoid separation of the salt as crystals and the resultant phase separation. Preferable organic solvents include polyols having 2 to 4 hydroxyl groups in the molecule, such as ethylene glycol, diethylene glycol, propylene glycol, dipropylene glycol, butanediols, 2,6-hexanediol and glycerine. Among the cited compounds most frequently used are ethylene glycol, diethylene glycol, propylene glycol, dipropylene glycol and 1,4-butanediol.

The delayed action gel catalysts are fully blocked or partially blocked with an organic carboxylic acid to yield a respective, blocked fully tertiary amine salt of the organic carboxylic acid or a partial salt of the organic carboxylic acid. The amount of organic carboxylic acid reacted with the tertiary amine gel catalyst depends upon the degree to which one desires to delay the tertiary amine catalytic activity. A fully blocked tertiary amine gel catalyst will have at least a 1:1 molar ratio of carboxylic acid equivalents to amine group equivalents. It is preferred that the tertiary amine gel catalyst is fully blocked within the polyol composition. In those cases where the delayed action feature is attributable to carboxylic acid blocking, is also preferred that the tertiary amine gel catalyst possess is blocked prior to addition into the polyol composition. Although it is within the scope of the invention that a fast acting gel catalyst may be added to the polyol composition along with a desired stoichiometric amount of formic acid separately added, this embodiment is not preferred because kinetically the formic acid may not find and bond to each gel catalyst molecule and/or may bond to amine initiated polyether polyols present in the polyol composition. Acid blocked amine catalysts such as these are described in, for example, U.S. Pat. No. 5,789,533, the disclosure of which is herein incorporated by reference.

Other acid blocked amine catalysts suitable for the present invention include those described in, for example U.S. Pat. Nos. 4,219,624, 5,112,878, 5,183,583, 6,395,796, 6,432,864 and 6,525,107, the disclosures of which are herein incorporated by reference.

Other suitable catalysts include organic metal compounds, especially organic tin, bismuth, and zinc compounds. Suitable organic tin compounds include those containing sulfur, such as dioctyl tin mercaptide (German Auslegeschrift 1,769,367 and U.S. Pat. No. 3,645,927), and, preferably, tin(II) salts of carboxylic acids, such as tin(II) acetate, tin(II) octoate, tin(II) ethylhexoate, and tin(II) laurate, as well as tin(IV) compounds, such as dibutyltin dilaurate, dibutyltin dichloride, dibutyltin diacetate, dibutytin maleate, and dioctyltin diacetate. Suitable bismuth compounds include bismuth neodecanoate, bismuth versalate, and various bismuth carboxylates known in the art. Suitable zinc compounds include zinc neodecanoate and zinc versalate. Mixed metal salts containing more than one metal (such as carboxylic acid salts containing both zinc and bismuth) are also suitable catalysts.

Suitable anti-oxidants for use as component (E) in the present invention include, for example, but are not limited to, those commercially available anti-oxidants such as UVINUL® A03 available from BASF Corporation and IRGANOX® 1010, IRGANOX® 1035 and IRGANOX® 1098, all of which are available from Ciba Specialty Chemicals Corporation. The anti-oxidants may be used in amounts of up to 2.0 weight percent of the elastomeric composition, with 0.25 weight percent to 1.0 weight percent being preferred.

Suitable UV stabilizers for use as component (F) in the present invention include, for example, example Tinuvin® 144, Tinuvin® 213, Tinuvin® 292, Tinuvin® 328, Tinuvin® 765, Tinuvin® 770, all of which are commercially available from Ciba Specialty Chemicals Corporation. The UV light stabilizer may be used in amounts of up to 2.0 weight % of the elastomeric composition, with 0.25 weight % to about 1.0 weight % being preferred.

Suitable colorants to be used as component (G) in the present invention include, for example, various coloring pigments and dyes such as, for example, carbon black, solvent black, titanium dioxide and the like.

Other suitable additives and auxiliary agents to be included in the present invention include, for example, molecular sieves (e.g. Baylith paste) and other non-reactive additives which reduce blistering and blowing or foaming during application of the solventless polyurethane coating system in humid weather or on damp substrates by combining with or adsorbing moisture and/or carbon dioxide. Suitable moisture scavenging additives include but are not limited to calcium sulfate, calcium oxide and synthetic zeolite “molecular sieves”. The amount of moisture scavenging additive used is increased according to the expected humidity at the point where the coating is to be applied. The moisture absorbing materials useful herein are known and are described in U.S. Pat. Nos. 3,755,222, 4,695,618 and 5,275,888, the disclosures of which are herein incorporated by reference. The fillers useful herein include silica, silica flour, barytes, talc, aluminum trihydrate, calcium carbonate, glass spheres, glass fibers and weaves, ceramic spheres and fibers, boron, carbon fibers, graphite, wollastonite, kieselguhr, organic fibers (such as polyamide fibers) and the like.

In the processes of forming composites using the above described spray polyurethaneurea compositions, can be in accordance with the processes as described in, for example, U.S. Pat. Nos. 6,294,248, 6,432,543 and 6,649,107, the disclosures of which are herein incorporated by reference. Suitable information in terms of: relevant processes and the corresponding steps for each process, suitable conditions, suitable molds, demold times, end uses, etc. are set forth in these references. Obviously, the spray elastomer compositions described hereinabove are substituted for the specific elastomer compositions of these references.

Various processes for the production of soft molded composites, and the corresponding molded composites are known and described as in, for example, U.S. Pat. Nos. 6,294,248 and 6,432,543, the disclosures of which are herein incorporated by reference. The unique aspect of these processes and the corresponding composites, lies in the improved spray elastomer compositions described hereinabove.

The following examples further illustrate details for the preparation and use of the compositions of this invention. The invention, which is set forth in the foregoing disclosure, is not to be limited either in spirit or scope by these examples. Those skilled in the art will readily understand that known variations of the conditions and processes of the following preparative procedures can be used to prepare these compositions. Unless otherwise noted, all temperatures are degrees Celsius and all parts and percentages are parts by weight and percentages by weight, respectively.

### EXAMPLES

The following components were used in Example 1:

| | |
|---|---|
| Amine A: | an amine terminated polyether polyol having a |
| | functionality of 2 and a molecular weight of about 400, |
| | being commercially available as Jeffamine D-400 from |
| | Huntsman Chemical |
| Polyol A: | a polyether polyol initiated with ethylene diamine and |
| | 100% propylene oxide, and having an OH number of |
| | about 630 a molecular weight of about 350 and a |
| | functionality of 4 |

### Example 1

### Preparation of an Internal Mold Release Agent

An internal mold release agent was prepared by combining three parts Amine A with two parts zinc stearate. The mixture was heated to 80° C. and stirred for one hour until homogeneous. Two parts of a Polyol A were added to the mixture and stirring maintained for an additional 30 minutes. The resulting mixture was a clear liquid and had a viscosity of 1265 cps @25° C.

The following components were used to prepare Polyol Blend I and in Examples 2-5:

| | |
|---|---|
| Polyol B: | a polyether polyol initiated with glycerine and |
| | propylene oxide (86% by wt.) and tipped with ethylene |
| | oxide (14% by wt.), and having an OH number of 28 |
| | and a functionality of 3 |
| Polyol C: | a polyether polyol initiated with propylene glycol and |
| | propylene oxide (80% by wt.) and tipped with ethylene |
| | oxide (20% by wt.), and having an OH number of 28 |
| | and a functionality of 2 |
| Polyol D: | a polyether polyol initiated with propylene glycol and |
| | propylene oxide (100% by wt.), and having an OH |
| | number of 56 and a functionality of 2 |
| DETDA: | diethyltoluenediamine, a blend of 80% by weight of |
| | the 2,4-isomer and 20% by weight of the 2,6-isomer |
| IPDA: | isophorone diamine |
| Catalyst A: | an amine catalyst, commercially available as Dabco ® |
| | 33LV from Air Products and Chemicals Inc. |
| Catalyst B: | an amine catalyst, commercially available as Dabco ® |
| | 1028 from Air Products and Chemicals Inc. |
| Stabilizer A: | Tinuvin ® 765, a UV stabilizer commercially available |
| | from Ciba Specialty Chemicals North America |
| Stabilizer B: | Tinuvin ® 213, a UV stabilizer commercially available |
| | from Ciba Specialty Chemicals North America |
| Antioxidant A: | Irganox ® 1135, an antioxidant additive commercially |
| | available from Ciba Specialty Chemicals North |
| | America |
| Isocyanate A: | an isocyanate prepolymer having an NOC group |
| | content of 9.8%, and comprising the reaction product |
| | of (i) 37.5 pbw of diphenylmethane diisocyanate |
| | comprising 40% by weight of the 2,2′- and 2,4′- |
| | isomers and 60% by weight of the 4,4′-isomer, with (ii) |
| | 62.5 pbw of Polyol D |

### Example 2-5

### The Polyol Blend Described Below was Used in these Examples

Polyol Blend I:

| Component: | pbw: |
|---|---|
| Polyol B | 75 |
| Polyol C | 10 |
| DETDA | 9.2 |
| IPDA | 2.5 |
| Catalyst A | 0.3 |
| Catalyst B | 0.5 |
| Stabilizer A | 1 |
| Stabilizer B | 1 |
| Antioxidant A | 0.5 |
| Total PBW: | 100 |

Polyol Blend I and Internal Mold Release Agent (IMR), as prepared in Example 1, were combined in relative quantities as shown in TABLE 1. Elastomers were then prepared by combining the mixture of Polyol Blend I and Internal Mold Release Agent by impingement mixing in a high pressure spray gun with the appropriate quantity of Isocyanate A so as to maintain an NCO/OH ratio of 1.02. The resultant elastomers were then tested for Taber Abrasion resistance according to ASTM D4060-95. Shore A Hardness of the resultant elastomers was also determined.

TABLE 1

| | | IMR from | Abrasion | |
|---|---|---|---|---|
| Example | Polyol Blend I | Example 1 | Resistance | Hardness |
| Number | (pbw) | (pbw) | (mg loss) | (Shore A) |
| 2 | 100 | 0.0 | 269.8 | 77 |
| 3 | 100 | 0.5 | 260.5 | 73 |
| 4 | 100 | 1.5 | 200.5 | 72 |
| 5 | 100 | 3.0 | 162.3 | 72 |

Although the invention has been described in detail in the foregoing for the purpose of illustration, it is to be understood that such detail is solely for that purpose and that variations can be made therein by those skilled in the art without departing from the spirit and scope of the invention except as it may be limited by the claims.

1. A spray elastomer comprising the reaction product of:
(A) a polyisocyanate or prepolymer thereof with an isocyanate content from about 6 to 20%;
with
(B) an isocyanate-reactive component comprising:
(1) from about 70 to about 97% by weight, based on 100% of the combined weight of components (B) and (C), of one or more compounds containing from about 1.5 to about 6 isocyanate-reactive groups having molecular weight of from about 60 to about 8,000, and an OH number of from about 14 to about 1870,
and
(2) from about 2.5 to about 20% by weight, based on 100% of the combined weight of components (B) and (C), of one or more compounds containing from about 2 to about 4 primary or secondary amine groups, having a molecular weight of from about 60 to about 500, and an NH number of from about 225 to about 1870;
(C) from about 0.5 to 10% based on 100% of the combined weight of components (B) and (C), of one or more internal mold release agents, which preferably comprises:
(1) from 5 to 50% by weight, based on the weight of (C), of one or more zinc carboxylates containing from about 8 to about 24 carbon atoms per carboxylate group,
and
(2) from 50 to 95% by weight, based on the weight of (C), of a compatibilizer selected from the group consisting of:
(a) amine-terminated polyether polyols having a functionality of from 2 to 4 and a molecular weight of from 200 to 5000,
(b) hydroxyl-terminated amine-initiated polyether polyols having a functionality of from 2 to 4 and a molecular weight of from 200 to 8000,
and
(c) mixtures thereof;
and, optionally,
(D) one or more catalysts,
(E) one or more anti-oxidants,
(F) one or more UV stabilizers,
and
(G) one or more colorants,
wherein the ratio of the total number of isocyanate groups present to the total number of isocyanate-reactive groups present is from about 0.80 to about 1.20.

2. The spray elastomer of claim 1, wherein (A) comprises a prepolymer of diphenylmethane diisocyanate having an NCO group content of 9 to 13% and which comprises the reaction product of: diphenylmethane diisocyanate comprising from about 2 to 60% by weight of the 2,4′-isomer of MDI, from about 0 to 5% by weight of the 2,2′-isomer of MDI, and from about 40 to 98% by weight of the 4,4′-isomer of MDI, with the %'s by weight of the 2,4′-isomer, the 2,2′-isomer and the 4,4′-isomer totaling 100% by weight of MDI; with an isocyanate-reactive component which contains from about 1.5 to 3 isocyanate-reactive groups, and has a molecular weight of from about 200 to about 8,000.

3. The spray elastomer of claim 1, wherein
(B) said isocyanate-reactive component comprises:
(2) from about 80 to 96% by weight, based on 100% of the combined weight of components (B) and (C), of a polyether polyol containing from about 2 to 4 hydroxyl groups, having a molecular weight of about 500 to 7,000 and an OH number of from about 20 to about 600,
and
(3) from about 3 to 15% by weight, based on 100% of the combined weight of components (B) and (C), of one or more compounds containing from about 2 to 3 primary and/or secondary amine groups, having a molecular weight of about 100 to 400, and an NH number of from about 280 to 1120;
and
(C) from about 1 to 6% by weight, based on 100% of the combined weight of components (B) and (C), of one or more internal mold release agents, which comprises:
(2) from 10 to 40% by weight, based on 100% by weight of (C), of at least one zinc carboxylate selected from the group consisting of: zinc stearate, zinc oleate, zinc octoate, zinc laurate, zinc behenate, zinc ricinoleate and mixtures thereof;
and
(3) from 60 to 90% by weight, based on 100% by weight of (C), of a compatibilizer selected from the group consisting of:
(a) amine-terminated polyether polyols having a functionality of from 2 to 3 and a molecular weight of from about 200 to 3,000,
and
(b) hydroxyl-terminated amine-initiated polyether polyols having a functionality of from 2 to 4 and a molecular weight of from 200 to 8000.

4. The spray elastomers of claim 1, wherein the ratio of the total number of isocyanate groups present to the total number of isocyanate-reactive groups present is from about 0.90 to about 1.10.

5. The spray elastomers of claim 1, wherein (C) said internal mold release agent comprises:
(1) zinc carboxylate,
and
(2) a compatibilizer selected from the group consisting of:
(a) a polyoxypropylene diamine and/or a polyoxypropylene triamine,
and
(b) a polyether polyol initiated with ethylene diamine, toluene diamine, ethanolamine, diethanolamine or triethanolamine and alkoxylated with propylene oxide and/or ethylene oxide.

6. A process for the production of a soft composite in a closed mold comprising:
(I) applying a composition which forms a soft elastomer to the interior walls of an open mold, wherein the composition comprises:
(A) a polyisocyanate or prepolymer thereof with an isocyanate content from about 6 to 20%;
with
(B) an isocyanate-reactive component comprising:
(1) from about 70 to about 97% by weight, based on 100% of the combined weight of components (B) and (C), of one or more compounds containing from about 1.5 to about 6 isocyanate-reactive groups having molecular weight of from about 60 to about 8,000, and an OH number of from about 14 to about 1870,
and
(2) from about 2.5 to about 20% by weight, based on 100% of the combined weight of components (B) and (C), of one or more compounds containing from about 2 to about 4 primary or secondary amine groups, having a molecular weight of from about 60 to about 500, and an NH number of from about 225 to about 1870;
(C) from about 0.5 to 10% based on 100% of the combined weight of components (B) and (C), of one or more internal mold release agents, which preferably comprises:
(1) from 5 to 50% by weight, based on the weight of (C), of one or more zinc carboxylates containing from about 8 to about 24 carbon atoms per carboxylate group,
and
(2) from 50 to 95% by weight, based on the weight of (C), of a compatibilizer selected from the group consisting of:
(a) amine-terminated polyether polyols having a functionality of from 2 to 4 and a molecular weight of from 200 to 5000,
(b) hydroxyl-terminated amine-initiated polyether polyols having a functionality of from 2 to 4 and a molecular weight of from 200 to 8000,
and
(c) mixtures thereof;
and, optionally,
(D) one or more catalysts, (preferably amine catalysts in OH group containing material),
(E) one or more anti-oxidants,
(F) one or more UV stabilizers,
and
(G) one or more colorants,
wherein the ratio of the total number of isocyanate groups present to the total number of isocyanate-reactive groups present is from about 0.80 to about 1.20;
(II) introducing a polyurethane and/or polyurea foam forming composition under molding conditions in an amount such that the resultant foam will fill the mold, into the mold in such a manner that this composition will be substantially completely within the elastomer-forming composition present on the walls;
(III) closing the mold;
and
(IV) allowing the composition introduced in (II) to form a foam.

7. The process of claim 6, wherein the elastomer-forming composition in (I) is sprayed onto the mold walls to a thickness of at least 30 mils.

8. The process of claim 6, wherein the composition applied in (I) forms an elastomer within from about 15 to about 120 seconds of application to the mold wall.

9. The process of claim 6, wherein the composition introduced into the mold in (II) forms a low density, high resiliency, flexible foam.

10. The process of claim 9, wherein the foam has a density of from about 1.8 to about 4.5 pcf, a recovery of at least 60% and a sag factor of at least 2.5.

11. The process of claim 6, wherein the composition applied in (I) is applied by spraying.

12. The process of claim 6, wherein the foam forming composition introduced in (II) is introduced by injecting it into the mold.

13. The process of claim 6, wherein the mold is a mold for a seat cushion or a cushion pad.

14. The process of claim 6, wherein step (III) is carried out prior to the introduction of the foam forming mixture in accordance with step (II).

15. The process of claim 6, wherein step (III) is carried out after step (II) has begun but prior to completion of step (IV).

16. The process of claim 6, wherein the foam forming composition introduced in step (II) forms a bonding layer with the elastomer in step (I).

17. The process of claim 6, wherein the resultant composite article is removed from the mold, and coated with a urethane based coating having a predetermined color.

18. The composite molded article produced by the process of claim 6.

19. The composite molded article produced by the process of claim 17.

20. A method of making a soft composite in a mold having a mold cavity, said method comprising:
(I) applying a urethane based coating having a predetermined color to the mold cavity;
(II) applying an elastomer-forming composition over the coating in the mold cavity and allowing the elastomer to at least partially cure to form an elastomeric layer, wherein the elastomer comprises the reaction product of:
(A) a polyisocyanate or prepolymer thereof with an isocyanate content from about 6 to 20%;
with
(B) an isocyanate-reactive component comprising:
(1) from about 70 to about 97% by weight, based on 100% of the combined weight of components (B) and (C), of one or more compounds containing from about 1.5 to about 6 isocyanate-reactive groups having molecular weight of from about 60 to about 8,000, and an OH number of from about 14 to about 1870,
and
(2) from about 2.5 to about 20% by weight, based on 100% of the combined weight of components (B) and (C), of one or more compounds containing from about 2 to about 4 primary or secondary amine groups, having a molecular weight of from about 60 to about 500, and an NH number of from about 225 to about 1870;
(C) from about 0.5 to 10% based on 100% of the combined weight of components (B) and (C), of one or more internal mold release agents, which preferably comprises:
(1) from 5 to 50% by weight, based on the weight of (C), of one or more zinc carboxylates containing from about 8 to about 24 carbon atoms per carboxylate group,
and
(2) from 50 to 95% by weight, based on the weight of (C), of a compatibilizer selected from the group consisting of:
(a) amine-terminated polyether polyols having a functionality of from 2 to 4 and a molecular weight of from 200 to 5000,
(b) hydroxyl-terminated amine-initiated polyether polyols having a functionality of from 2 to 4 and a molecular weight of from 200 to 8000,
and
(c) mixtures thereof;
and, optionally,
(D) one or more catalysts,
(E) one or more anti-oxidants,
(F) one or more UV stabilizers,
and
(G) one or more colorants,
wherein the ratio of the total number of isocyanate groups present to the total number of isocyanate-reactive groups present is from about 0.80 to about 1.20;
and
(III) demolding the resultant soft composite.

21. The method of claim 20, further comprising introducing a polyurethane and/or polyurea foam forming composition into the mold cavity and applying the foam forming composition to the elastomeric layer to form a backing layer on the soft composite.

22. The method of claim 20, further comprising applying a polyurethane foam forming composition to the elastomeric layer after demolding the soft composite.

23. The method of claim 20, wherein the elastomer-forming composition applied in (II) is applied by spraying.

24. The soft composite produced by the method of claim 20.

25. A method of making a soft composite in a mold having a mold cavity, said method comprising:
(I) applying an elastomer-forming composition within the mold cavity and allowing the elastomer-forming composition to at least partially cure, thereby forming an elastomeric layer, wherein the elastomer-forming composition comprises the reaction product of:
(A) a polyisocyanate or prepolymer thereof with an isocyanate content from about 6 to 20%;
with
(B) an isocyanate-reactive component comprising:
(1) from about 70 to about 97% by weight, based on 100% of the combined weight of components (B) and (C), of one or more compounds containing from about 1.5 to about 6 isocyanate-reactive groups having molecular weight of from about 60 to about 8,000, and an OH number of from about 14 to about 1870,
and
(2) from about 2.5 to about 20% by weight, based on 100% of the combined weight of components (B) and (C), of one or more compounds containing from about 2 to about 4 primary or secondary amine groups, having a molecular weight of from about 60 to about 500, and an NH number of from about 225 to about 1870;
(C) from about 0.5 to 10% based on 100% of the combined weight of components (B) and (C), of one or more internal mold release agents, which comprises:
(1) from 5 to 50% by weight, based on the weight of (C), of one or more zinc carboxylates containing from about 8 to about 24 carbon atoms per carboxylate group,
and
(2) from 50 to 95% by weight, based on the weight of (C), of a compatibilizer selected from the group consisting of:
(a) amine-terminated polyether polyols having a functionality of from 2 to 4 and a molecular weight of from 200 to 5000,
(b) hydroxyl-terminated amine-initiated polyether polyols having a functionality of from 2 to 4 and a molecular weight of from 200 to 8000,
and
(c) mixtures thereof;
and, optionally,
(D) one or more catalysts,
(E) one or more anti-oxidants,
(F) one or more UV stabilizers,
and
(G) one or more colorants,
wherein the ratio of the total number of isocyanate groups present to the total number of isocyanate-reactive groups present is from about 0.80 to about 1.20;
(II) optionally, introducing a polyurethane and/or polyurea foam-forming composition into the mold cavity and applying the foam-forming composition to the at least partially cured elastomeric layer to form a backing layer on the soft composite;
and
(III) demolding the resultant soft composite.

26. The method of claim 25, further comprising applying a urethane based coating to the mold cavity prior to (I).

27. The method of claim 25, further comprising applying a urethane based coating to the elastomeric layer after demolding the resultant soft composite.

28. The soft composite produced by the method of claim 25.
